(19) United States
(12) Patent Application Publication
(10) Pub. No.: US 2007/0278866 A1
(43) Pub. Date: Dec. 6, 2007

(54) SLIDING SYSTEM WITH ONBOARD MOVING-MAGNET LINEAR MOTOR

(75) Inventors: Eiji Ida, Kamakura-shi (JP); Masaki Ohno, Kamakura-shi (JP)

Correspondence Address: BROWDY AND NEIMARK, P.L.L.C.;624 NINTH STREET, NW, SUITE 300, WASHINGTON, DC, 20001-5303, US

(73) Assignee: Nippon Thompson Co., Ltd., Minato-ku (JP)

(21) Appl. No.: 11/756,147

(22) Filed: May 31, 2007

(30) Foreign Application Priority Data
May 31, 2006 (JP) 2006-151586

(51) Int. Cl. H02K 41/00

(52) U.S. Cl. 310/12

(57) ABSTRACT

A sliding system has a coil spring to keep balance in weight when a table moves up and down on the bed placed in upright posture. The sliding system is comprised of a bed, a table allowed to move relatively to the bed, a linear motor including a field magnet secured on the table and composed of magnet strips juxtaposed in an array that their polarities alternate in an sliding direction of the table, and an armature assembly having coreless armature windings of flat configuration lying on the bed in opposition to the field magnet, and a coil spring fastened to the bed and the table. The coil spring is constantly energized with any spring force across an effective stroke covering reciprocal traveling range of the table relatively to the bed.

### FIELD OF THE INVENTION

The present invention relates to a sliding system with onboard moving-magnet linear motor, which has been extensively used in fields as diverse as semiconductor industries, various assembling machines, measuring instruments, and so on.

### BACKGROUND OF THE INVENTION

Sliding systems with onboard small linear motor have been used in years in extensively increased industrial fields. Modern sliding systems with onboard linear motor are further finding a multitude of potential applications. Advanced sliding systems with onboard linear motor are needed especially to meet design specifications anticipated working in upright posture with performances including rapid operating velocity, high acceleration/deceleration, quickly responsive, highly accurate position-control, and so on.

A prior sliding device with onboard small linear motor is disclosed in, for example the commonly assigned Japanese Patent Laid-Open No. 2001-352744 in which a stationary bed and a moving table are both made of magnetic material while there are built in a small linear motor composed of at least three of armature windings required for a three-phase conduction system, one to each phase current, and correspondingly five of field magnets, making it possible to render the sliding system slim or compact in construction with serving working functions of high propulsion, rapid operating velocity, highly responsive ability and highly accurate position-control. With the prior sliding device in which an armature assembly is designed to carry the three-phase current, a driving circuit gets turned over from the interior of the sliding device to any other driver side to make the bed simpler in construction as well as the sliding device itself less in the overall height in thickness direction. The field magnets are made of permanent magnet strips of rare earth element, for example neodymium, which is high in flux density to enhance the propulsion exerted on the moving table. An encoder to sense the position of the table is constituted with an optical encoder having an optical linear scale to ensure accurate position control. With the prior sliding device constructed as stated earlier, the sensing cables, lines, and so on are tethered to the stationary side and, therefore, there is less possibility of causing dust and dirt. Thus, the prior sliding device is qualified for clean environment and better for making the working and responsive performances of the table relatively to the bed higher or more sensitive, with high accuracy of position control of the table relatively to the bed.

A machine tool with linear motor is disclosed in, for example Japanese Patent Laid-Open No. 2004-122285 in which a spindle head driven by a linear motor is kept against a drop as a power outage. The safeguard for the spindle head is provided to keep the spindle head from coming down on its own weight if a lifting linear motor comes into any uncontrolled manner as a power outage or any emergency occurs to the machine tool, resulting in deenergization of the machine tool. With the safeguard for the spindle, the spindle head has brake blocks and further is flanked by brake rods connected to columns that are allowed to move sidewise on guide rails. The brake blocks are actuated upon deenergization of the machine tool to grasp the associated brake rods on axially opposite sides of the brake rods by the action of resilient force of built-in braking springs.

Meanwhile, the sliding systems with onboard linear motor are needed in years to meet design specifications anticipated working in upright posture. However, the safeguard to keep the spindle head against a drop constructed as recited earlier, as requiring the installation of special parts including brake rods and so on, could not shun becoming adversely bulky in construction. Thus, it remains a major challenge to make the sliding system simpler in construction.

On the other side, a sliding system with onboard linear motor is disclosed in a commonly-assigned senior Japanese patent application, which was opened to public with Japanese Patent Laid-Open No. 2006-238540 after the Convention priority date of this application. The sliding system has an X-table allowed to travel in any one horizontal direction or X-direction and a Z-table allowed to move in a vertical direction or a Z-direction perpendicular to the X-direction in such a relation that combined relative movement of the X- and Z-tables with one another makes accurate position control. Moreover, the Z-table has an equalizer spring to keep its balance on weight. With the sliding system constructed as stated just earlier, however, the Z-table is made in a specialty of L-shape. This unique construction of the Z-table is unbefitting for versatility of applications in upright posture to unidirectional sliding system most universal in industries.

The sliding system disclosed in the commonly-assigned senior application is comprised of a bed of flat configuration, a first table lying in opposition to the bed in a way allowed to move in any one direction, a second table lying in opposition to the first table in a way allowed to move in another direction perpendicular to the one direction, a first linear motor energized to control in position any one of the bed and the first table relatively to the other in the one direction, and a second linear motor energized to control in position any one of the first and second tables relatively to the other in the another direction. Especially, the second table is arranged in opposition to the first table at the same side of the first table as the bed is laid. With the sliding system constructed as stated earlier, moreover, the first table is allowed to move in and out in the X-direction towards any desired position while the second table is allowed to move in and out in the Z-direction towards any desired position. The bed and the second table are both arranged on the same side of the first table to render the sliding system in itself as a whole slim or compact in height or thickness. Thus, the sliding system is made less in height or thickness than the previous version of the same sort as constructed to make position control in the coordinates of X- and Z-directions with the onboard linear motors.

### SUMMARY OF THE INVENTION

The present invention has as its primary object to overcome the subject stated earlier and more particular to provide a sliding system befitting for unidirectional position-control. More particularly, it relates to a sliding system in which an equalizer spring is provided between a table and a bed to exert constantly a working force on the table toward a balancing position, getting the table together with any mass, such as workpiece, instruments, and so on, mounted on the table balancing itself out on weight. With the sliding system of the present invention, the spring force or spring effect in just reciprocating motion serves as a propulsive assist upon acceleration and/or deceleration of the table, helping reduce the mass of load or moving parts thereby to achieve high acceleration performance.

The present invention is concerned with a sliding system with onboard linear motor; comprising an elongated bed of flat configuration, a flat table lying in opposition to the bed in a way allowed to move in a lengthwise direction of the bed by virtue of a linear motion guide unit, and a linear motor comprised of a field magnet secured on one surface of the table facing on the bed and composed of magnet strips juxtaposed in an array that their polarities alternate in an sliding direction of the table, and an armature assembly having coreless armature windings of flat configuration lying on one surface of the bed facing on the table in opposition to the field magnet; and wherein a coil spring is fastened to the bed and the table.

In one aspect of the present invention, a sliding system with onboard linear motor is provided in which the coil spring is constantly energized with any spring force across an effective stroke covering reciprocal traveling range of the table relatively to the bed.

In another aspect of the present invention, a sliding system with onboard linear motor is provided in which the coil spring is placed along either side of widthwise opposite sides of both the bed and table in a way lying in parallel with a raceway groove cut in a guide rail of the linear motion guide unit.

In another aspect of the present invention, a sliding system with onboard linear motor is provided in which the coil spring makes engagement at any one end thereof with a bearing lug and another end thereof with a bracket of a suspension plate, and wherein the bearing lug extends from any one side of an end block fastened to any one end of the bed, while the suspension plate is fastened to the same side of the table, and wherein the coil spring is held in a geometry that a lengthwise center line thereof is in flush with the surface of the bed facing the table.

In a further another aspect of the present invention, a sliding system with onboard linear motor is provided in which the suspension plate lying on the table includes a major plate fastened on the side of the table, and a bracket raised above the major plate at any one side edge of the major plate to form an L-shaped angle to make engagement with the coil spring.

In another aspect of the present invention, a sliding system with onboard linear motor is provided in which the bed is made in part of magnetic material to serve as a coil yoke to establish magnetic circuits while the table is also made in part of magnetic material to serve as a magnet yoke to establish magnetic circuits.

In another aspect of the present invention, a sliding system with onboard linear motor is provided in which a linear scale for an encoder is secured on the surface of the table facing on the bed in a way extending lengthwise of the table closely to the side of the table opposed sidewise to the side on which is fastened the suspension plate, while a sensor for the encoder is placed on the surface of the bed facing the table in opposition to the linear scale.

In another aspect of the present invention, a sliding system with onboard linear motor is provided in which the armature assembly has three of the armature windings, each of which carries each phase of the three-phase system, while the filed magnet is composed of five permanent magnet strips of rare earth, which are juxtaposed closely in a way alternating in polarity.

In a further another aspect of the present invention, a sliding system with onboard linear motor is provided in which the coil spring is made to have the spring force that is in balance with a total weight of a weight of the table and a load to get the table keeping still at a middle point of an overall stroke of the table when the table carries the load thereon while the bed is disposed standing upright posture in such a geometry that the end block whose the bearing lug makes engagement with the one and of the spring lies up.

With the sliding system constructed as stated earlier according to the present invention, the coil spring is installed to connect the bed with the table in a way the spring force thereof is commensurate with the overall mass of the table and the load carried onboard. When used in diverse machines working in upright or vertical posture including semiconductor fabricating equipment, various assembling machines, measurement/inspection instruments, testing instruments, machine tools, and so on, the table is kept in steady balance, allowed following rapidly the desired working with high speed and high acceleration and performing the position control with accuracy.

The above and other related aspects and features of the present invention will be more apparent to those skilled in the art from a reading of the following description of the disclosure found in the accompanying drawings and the novelty thereof pointed out in the appended claims.

### BRIEF DESCRIPTION OF THE DRAWINGS

FIG. 1 is a view in top plan of a preferred embodiment of a sliding system with onboard moving-magnet linear motor according to the present invention:

FIG. 2 is a view in side elevation of the sliding system of FIG. 1:

FIG. 3 is a view in transverse section of the sliding system of FIG. 1, the view being taken on the plane normal to the lengthwise direction of the sliding system:

FIG. 4 is a view in top plan of the sliding system of FIG. 1, but in which a table and a spring are removed:

FIG. 5 is a view in bottom plan of a table, in which the table is separated apart from the sliding system and turned upside down:

FIG. 6 is a view in plan of a supporting panel for the sliding system of FIG. 1:

FIG. 7 is a view in side elevation of the supporting panel of FIG. 6: and

FIG. 8 is a composite graph illustrating difference in observed results on position-control accuracy between with a spring and no spring of FIG. 1.

### DETAILED DESCRIPTION OF THE PREFERRED EMBODIMENTS

Preferred embodiments of a sliding system with onboard moving-magnet linear motor according to the present invention will be explained later in detail with reference to the accompanying drawings.

The sliding system with onboard moving-magnet linear motor of the present invention is considered best suited for incorporating it in a diversity of machinery including semiconductor manufacturing equipments, various assembling machines, and so on.

The sliding system with onboard linear motor of the present invention is envisaged incorporating it in a diversity of machinery including semiconductor manufacturing equipments, various assembling machines, measurement/inspection equipments, testing instruments, machine tools, and so on, which are expected to work in any controlled atmosphere as in, for example clean rooms, testing/experimental laboratories, and the like. More particular, the sliding system developed according to the present invention is expected to meet design specifications anticipated working in upright posture.

The sliding system of the present invention is mainly comprised of an elongated flat bed 1 of magnetic material or steel, a table 2 of magnetic material or steel allowed to travel lengthwise of the bed 1 by virtue of a linear motion guide unit 22, and a linear encoder 26 to sense a relative position of the table 2 in sliding direction thereof with respect to the bed 1. On any one surface 36 of the table 2 facing the bed 1, there is placed a field magnet 20 of many magnetic poles or magnet segments 21, five magnet strips in the version illustrated, lying closely in juxtaposition in a way unlike magnetic poles alternate in polarity. On any one surface 37 of the bed 1 opposite to the table 2, there is provided an armature assembly 15 having many coreless armature windings 16 wound in the form of flat configuration and laid closely in juxtaposition in the sliding direction and in opposition to the field magnet 20. With the sliding system constructed as stated earlier, the propulsion to carry out the position control is given from electromagnetic interaction of the flux created by of the field magnet 20 with the current flowing in the armature windings 16. The bed 1 has holes 18 which are used to fasten any machines, instruments, and so on thereto with screws. The armature assembly is made to carry the three-phase conduction system and, correspondingly, has three armature windings 16, each of which carries each phase of the three-phase system. The armature windings 16 are all concealed with a covering board 17. The filed magnet 20 is composed of five magnet segments 21 of permanent magnet strips of rare earth, which are juxtaposed closely in a way alternating in polarity. Moreover, the linear encoder 26 is made of an optical linear encoder that is composed of an optical linear scale 24 secured on the table 2 along the sliding direction and a sensor 19 installed on the bed 1 in opposition to the optical linear scale 24 to read the linear scale 24.

With the sliding system of the present invention, the bed 1 has at upper and lower ends thereof upside end block 4 and downside end block 6 respectively. The upside end block 4 is intended to provide a connector block to shield wiring connections of a power line 13 leading to the armature assembly 15 and a signal line 14 leading to the sensor 19 of the encoder 26. Although but both the power line 13 and signal line 14 are shown as extending above the upside end of the bed 1 in the illustrated version, it will be appreciated that the upside end block 4 for the connector block may be replaced with another end block 6 upside down in a fashion allowing the power line 13 and signal line 14 extending below the lower end of the bed 1. Moreover, the end blocks 4 and 6 each have a stopper 10 of elastic material to relieve collision of the table 2 against the bed 1. The linear motion guide unit 22 is composed of a pair of guide rails 3 screwed to the bed 1 in a manner extending lengthwise or in a sliding direction of the table 2, and four sliders 23 secured to the table 2 so as to fit over the associated guide rails 3 in a way allowed to move along the guide rail 3 by virtue of rolling elements, not shown. The table 2 has matching holes 27 that allow fastening screws 31 to extend through there to secure the sliders 23 to the table 2. More than one rolling element is built in the linear motion guide unit 22 to roll through load races defined between raceway grooves in the sliders 23 and their associated lengthwise raceway grooves on the guide rails 3 as the sliders 23 moves back and forth along the guide rails 3.

The sliding system of the present invention features a coil spring 5 installed between the bed 1 and the table 2 to render the sliding systems easier to use them in their upright or vertical posture, thereby expanding the scope of their useful applications. With the sliding system with the coil spring 5 as stated above, there is no need of other means including any counter balance, and so on even if used in the upright or vertical posture or geometry. Simple construction of just a coil to get the mass balancing requires less space and therefore may avail in any cramped space.

With the sliding system of the present invention, the coil spring 5 is constantly energized with any spring force across an effective stroke(S) covering reciprocal traveling range of the table 2 relatively to the bed 1. The coil spring 5 is placed along either side 38 of widthwise opposite sides of both the bed 1 and table 2 in a way lying in parallel with the raceway grooves cut in the guide rail 3 of the linear motion guide unit 22. The coil spring 5 makes engagement at any one hooked end 39 thereof with a bearing lug 7 and at another end 40 thereof with a bracket 9 of a suspension plate 8. The bearing lug 7 extends sidewise from any one side 38 of the end block 4 fastened to the upside end of the bed 1, while the suspension plate 8 is screwed by screws 35 to the same side 38 of the table 2. Moreover, the coil spring 5 is held in a geometry that the lengthwise center lines thereof is in flush with the surface 37 of the bed 1 facing the table 2. More especially, the coil spring 5 fits at the end 39 thereof into a hole 32 made in the bearing lug 7 and at the opposing end 40 into another hole 30 bored through the bracket 9 of the suspension plate 8.

With the sliding system constructed as stated earlier, the suspension plate 8 lying on the table 2 includes a major plate 28 fastened on the side 38 of the table 2, and a bracket 9 raised above the major plate 28 at any one side edge of the major plate 28 to form an L-shaped angle to make engagement with the coil spring 5. Moreover, the bed 1 is made in part of magnetic material to serve as a coil yoke 33 to establish magnetic circuits, while the table 2 is also made in part of magnetic material to serve as a magnet yoke 34 to establish magnetic circuits. With the sliding system of this invention, the linear scale 24 for the encoder 26 is secured on the inside surface 36 of the table 2 in a way extending lengthwise of the table 2 closely to the side of the table 2 opposed sidewise to the side 38 on which is fastened the suspension plate 8. On the inside surface 37 of the bed 1 facing the table 2, there is placed the sensor 19 for the encoder 26 in opposition to the linear scale 24. On the inside surface 36 of the table 2, there is provided an origin mark 25 in addition to the linear scale 24 extending lengthwise in the sliding direction.

With the sliding system of the present invention, the armature assembly 15, especially, has a set of three armature windings 16, each of which carries each phase of the three-phase system, while the filed magnet 20 is composed of five magnet segments 21 of permanent magnet strips of rare earth, which are juxtaposed closely in a way alternating in polarity. The linear motor constructed as stated earlier renders the sliding system compact in construction even with maintaining high propulsion, high speed, highly responsive property, and high accuracy in position control. The linear motor further makes it possible to use the sliding systems in the upright or vertical posture or geometry, thereby making for expanding the scope of their applications. The table 2 has threaded holes 12 that are used to screw any object including work and so on to the table 2. Considering now that the bed 2 is disposed standing upright or vertical posture while the table 2 with a load 11 is placed on the bed 1 with the end block 4 lying up and the coil spring 5 is joined at the upside end 39 thereof to the bearing lug 7 fastened to the end block 4, the coil spring 5 is designed to have the spring force that is in balance with the total weight (Wg) of the weight (Wo) of the table 2 and the load (Wt) to get the table 2 keeping still or its equilibrium position at a middle point of the overall stroke(S) of the table 2.

With the sliding system of the present invention, moreover, the coil spring 5 is set to exert the spring force or tensile force constantly across the stroke(S) or the reciprocating range of the table 2. In FIG. 1, the table 2 is shown in its equilibrium state (Pm) where the table 2 stands still at a middle point of its overall stroke(S) while the coil spring 5 stretches the length (L2) away from its free length (L) to develop a spring force (F2) heading the bearing lug 7 fastened to the upside end block 4. Thus, the spring force (F2) of the coil spring 5, when the sliding system is used in the upright posture with the bearing lug 7 on the end block 4 being placed up, is determined to be in balance with the total weight (Wg) of the weight (Wo) of the table 2 and the load (Wt), that is, (Wg)=(Wo)+(Wt), thereby keeping still or the balanced position (Pm). When the table 2 is displaced to any one terminal or starting point (Ps) of the effective stroke(S) of the table 2, the coil spring 5 stretches the length (L1) away from its free length (L) to develop a spring force (F1) heading the bearing lug 7 fastened to the upside end block 4. On the other side, when the table 2 is displaced to another terminal or ending point (Pe) of the effective stroke(S) of the table 2, the coil spring 5 stretches the length (L3) away from its free length (L) to develop a spring force (F3) heading the bearing lug 7 fastened to the upside end block 4.

When the sliding system of the present invention is used in the upright or vertical posture with the bearing lug 7 on the end block 4 being placed upward, the table 2 undergoes constantly the total load (Wg) [(=Wo+Wt)] of the weight (Wo) of the table 2 and the load (Wt), in the perpendicular or gravitational direction. If taking the spring force of the coil spring 5 into account, the table 2 displaced to the starting point (Ps) experiences an applied force (Fs)=(Wg)−(F1) heading the middle or the balanced position (Pm), while the table 2 displaced to the ending point (Pe) experiences an applied force (Fe)=(F3)−(Wg) heading the middle or the balanced position (Pm).

With the sliding system constructed as stated earlier for befitting to work in the upright posture, the moving table 2 is kept in balance in weight with the coil spring 5 to cause constantly the applied force heading the balanced or equilibrium state. Thus, the coil spring 5 is less in mass increase of the moving part compared with other balancing mechanism, making sure of high acceleration performance inherent in the sliding system. With the sliding system of the present invention, moreover, the spring force or tensile force of the coil spring 5 serves to assist the prolusion at the time of acceleration and/or deceleration in simple reciprocating motion to provide the benefit of reducing any load applied to the linear motor. If the sliding system is used in standing position, the coil spring 5 functions to sustain the table 2 within the range of effective stroke(S) at its beginning phase and, therefore, the built-in linear motor at its initial working can sense the polarity in the field magnet 20, making it possible to determine power factor to get the three-phase current flowing in time for the sensed position. The method of determining power factor, for example, is of the type in which phases in the magnet and winding are discriminated from one another through a behavior found when the winding carries a preselected amount of current after any power source has been thrown in. Once the phases were discriminated, the polarity could be figured out based on counted value of encoder signals, after seeing the dimension in width of the magnet was known.

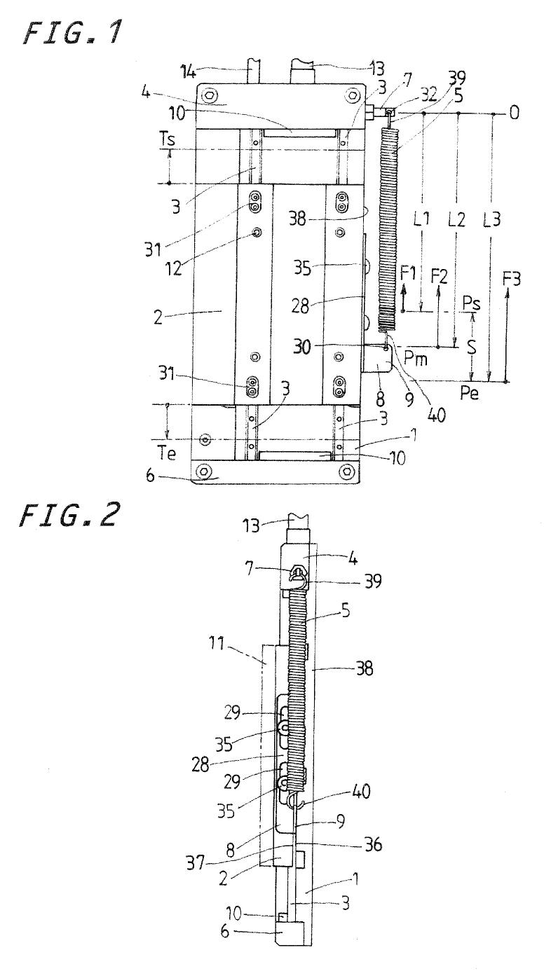

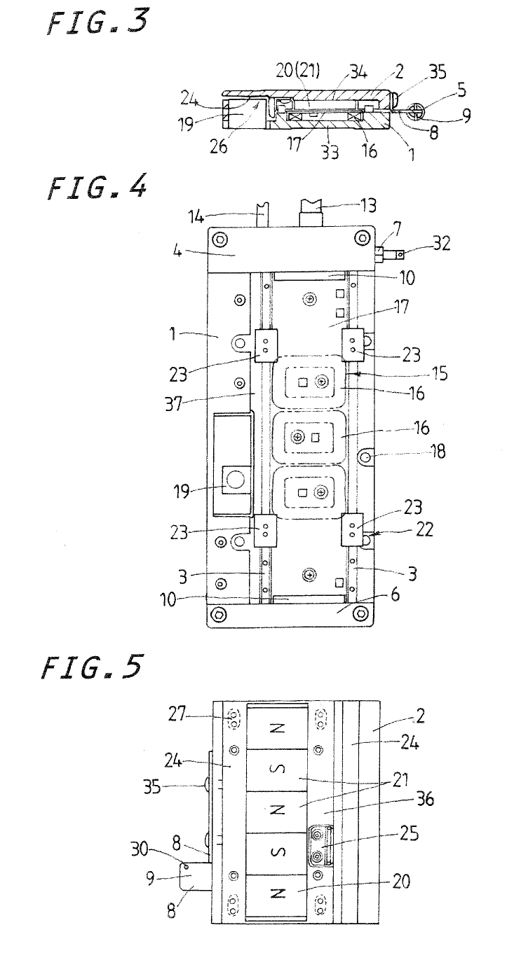

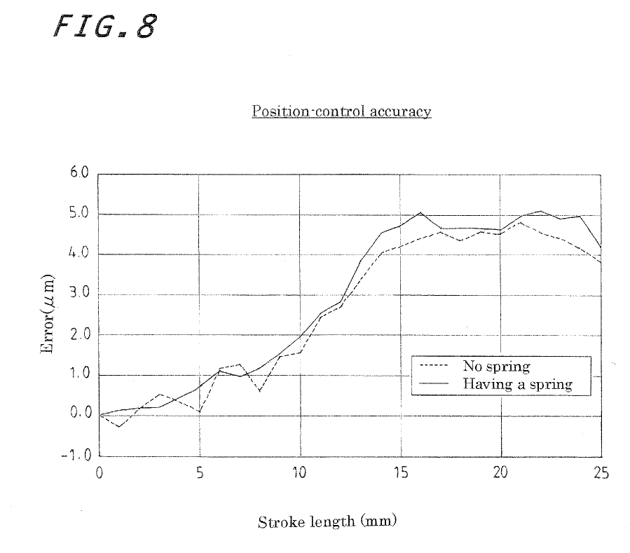

The coil spring 5, as shown in FIGS. 1 to 3, is arranged on the same sides 38 of the bed 1 and table 2. With the sliding system of the present invention envisaged shrinking it down to the size as small as permitted, the coil spring 5 is placed on any one side 38 of the widthwise opposing sides while the linear encoder 26 is on the other side. Of course, it would be best to arrange the coil springs 5 on either side of widthwise opposite sides of the bed 1 and the table 2, one to each side, but such arrangement of the coil springs 5 is impracticable due to lack of space because the linear encoder 26 was laid on the other side. With the sliding system constructed as stated earlier, it would be considered for the reason recited earlier that the coil spring 5 could end up exerting a torque on the table 2, negatively affecting the accurate position control. As apparent from FIG. 8, nevertheless, a difference in error on position-control accuracy between with a spring and with no spring was found only less than 1 μm over the effective stroke. This means that the sliding system with a single spring, as less vulnerable to the torque, is said to be viable. A composite graph in FIG. 8 proved there was little difference in error (μm) on position-control accuracy between with a spring and no spring over the stroke(S) of from 0 to 25 mm of the table 2.

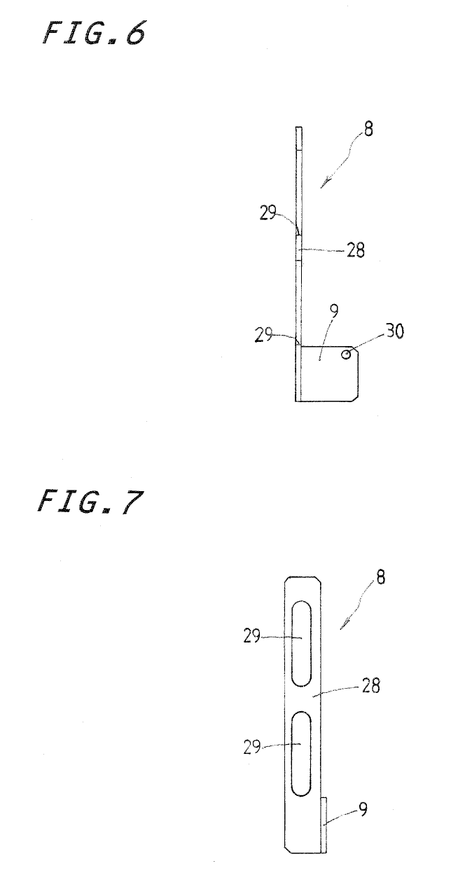

The coil spring 5, as shown in FIGS. 1 to 3, 6 and 7, engages at one end 39 thereof with the bearing lug 7 raised above the side 38 of the end block 4 fastened to any one end of the bed 1, while at another end 40 thereof with the suspension plate 8 secured on the same side 38 of the table 2. The coil spring 5 extends along the coexisting side of the bed 1 and table 2 in geometry the lengthwise center line of the coil spring 5 is in flush with the surface 37 of the bed 1 facing the table 2. The suspension plate 8 includes the major plate 28 having therein slots 29 that are used to fasten the suspension plate 8 to the associated site 38 of the table 2, and the bracket 9 rising at one end of the major plate 28 away from the bearing lug 7 in a way extending along any one side edge of the major plate 28 to form an L-shaped angle. The linear motion guide unit 22 installed in the sliding system of the present invention is comprised of a pair of guide rails 3 secured on the bed 2 in a way lying lengthwise of the bed 1, and sliders 23 secured to the table 2 to fit over the associated guide rails 3 in a way allowed to move along the guide rail 3 by virtue of rolling elements or balls. The coil spring 5 especially lies in a geometric relation that the lengthwise center line thereof is in flush with the raceway grooves cut in the guide rails 3 of the linear motion guide unit 22. With the geometry of the coil spring 5 as stated earlier, there is no likelihood that the coil spring 5 will cause any twisting force working adversely on the table 2, so that the linear motion guide unit 22 ensures smooth movement of the table 2 along the guide rails 3. The suspension plate 8 formed as shown in FIGS. 6 and 7 can be tailored easily for position setting even if the coil springs 5 are needed to alter or change their spring standards depending on the mass of load, working conditions, and so on.

With the sliding system constructed as stated earlier, the moving table 2 has thereon the field magnet 20 and the optical linear scale 24 for the linear encoder, while the stator bed 1 is provided thereon with the winding assembly 15 made up of the armature windings 16 and the board 17, and the sensor head for the linear encoder. The field magnet 21 and the winding yoke 33 together form the magnetic field or flux that acts in the direction perpendicular to the sliding direction, while the circular magnetic flux occurs around the armature winding 16 carrying a steady electric current. Thus, the magnetic flux confined between field magnet 21 and the winding yoke 33 and the circular magnetic flux around the armature winding in combination generate a force to actuate the armature winding 16 in the sliding direction in conformity with Fleming's left-hand rule. With the sliding system constructed as stated earlier, if changing the electric current in the armature winding 16 depending on the direction of the magnetic flux, the unidirectional propulsion occurs continuously to ensure the sustained linear movement of the moving table 2. Accurate position-control of the table 2, moreover, is carried out by the combination of the acceleration control according to the amount of current and the position-feedback operation using the optical linear encoder.

The followings are design considerations and calculations to really render the sliding system of the present invention viable on best mode.

(1) Requirements for the sliding system when used in its upright posture: a mass carried onboard was 200 g; a stroke, 25 mm; a top velocity, 600 mm/sec; a time it took for acceleration/deceleration, 0.02 sec; a time to stop, 0.05 sec; effective propulsion, 6.2N; and a mass of the table, 170 g.

(2) Design considerations: a diameter of wire was 0.6 mm; an outside diameter of a coil spring, 6 mm; a length of a coil spring when subjected to no load, 60 mm; spring rate, 0.1N/mm; and an initial tensile force, 1.23N.

(3) Calculations:
1) When compressed to (L1)=71.5 mm

71.5−60=11.5

11.5×0.1+1.23=2.38
Thus, the spring force (F1) was 2.38N
2) When extended to (L2)=84 mm

84−60=24

24×0.1+1.23=3.63
Thus, the spring force (F2) was 3.63N
3) When further extended to (L3)=96.5 mm

96.5−60=36.5

36.5×0.1+1.23=4.88
Thus, the spring force (F3) was 4.88N
Considering the mass carried onboard of 200 g and the mass of table of 170 g, the overall load (Wg) was up to 370 gf=0.37 kgf
Thus, the spring force F3 resulted in 0.370×9.8=3.63N.
This was identical with the (F2) and therefore meant the spring came into balance at the middle of the effective stroke(S).
Moreover, F2 [=(Wg)]−(F1)=(Fs), namely, 3.63N−2.38N=1.25N, while (F3)−(F2) [=(Wg)]=(Fe), namely, 4.88N−3.63N=1.25N
Thus, in the upright posture there were (Fs)=1.25N and Fe=1.25N.

What is claimed is:

1. A sliding system with onboard linear motor; comprising an elongated bed of flat configuration, a flat table lying in opposition to the bed in a way allowed to move in a lengthwise direction of the bed by virtue of a linear motion guide unit, and a linear motor comprised of a field magnet secured on one surface of the table facing on the bed and composed of magnet strips juxtaposed in an array that their polarities alternate in an sliding direction of the table, and an armature assembly having coreless armature windings of flat configuration lying on one surface of the bed facing on the table in opposition to the field magnet; and
wherein a coil spring is fastened to the bed and the table.

2. A sliding system with onboard linear motor constructed as recited in claim 1, wherein the coil spring is constantly energized with any spring force across an effective stroke covering reciprocal traveling range of the table relatively to the bed.

3. A sliding system with onboard linear motor constructed as recited in claim 1, wherein the coil spring is placed along either side of widthwise opposite sides of both the bed and table in a way lying in parallel with a raceway groove cut in a guide rail of the linear motion guide unit.

4. A sliding system with onboard linear motor constructed as recited in claim 1, wherein the coil spring makes engagement at any one end thereof with a bearing lug and another end thereof with a bracket of a suspension plate, and wherein the bearing lug extends from any one side of an end block fastened to any one end of the bed, while the suspension plate is fastened to the same side of the table, and wherein the coil spring is held in a geometry that a lengthwise center line thereof is in flush with the surface of the bed facing the table.

5. A sliding system with onboard linear motor constructed as recited in claim 4, wherein the suspension plate lying on the table includes a major plate fastened on the side of the table, and a bracket raised above the major plate at any one side edge of the major plate to form an L-shaped angle to make engagement with the coil spring.

6. A sliding system with onboard linear motor constructed as recited in claim 1, wherein the bed is made in part of magnetic material to serve as a coil yoke to establish magnetic circuits while the table is also made in part of magnetic material to serve as a magnet yoke to establish magnetic circuits.

7. A sliding system with onboard linear motor constructed as recited in claim 4, wherein a linear scale for an encoder is secured on the surface of the table facing on the bed in a way extending lengthwise of the table closely to the side of the table opposed sidewise to the side on which is fastened the suspension plate, while a sensor for the encoder is placed on the surface of the bed facing the table in opposition to the linear scale.

8. A sliding system with onboard linear motor constructed as recited in claim 1, wherein the armature assembly has three of the armature windings, each of which carries each phase of the three-phase system, while the filed magnet is composed of five permanent magnet strips of rare earth, which are juxtaposed closely in a way alternating in polarity.

9. A sliding system with onboard linear motor constructed as recited in claim 4, wherein the coil spring is made to have the spring force that is in balance with a total weight of a weight of the table and a load to get the table keeping still at a middle point of an overall stroke of the table when the table carries the load thereon while the bed is disposed standing upright posture in such a geometry that the end block whose the bearing lug makes engagement with the one and of the spring lies up.
